(19) United States
(12) Patent Application Publication
(10) Pub. No.: US 2022/0093358 A1
(43) Pub. Date: Mar. 24, 2022

(54) X-Ray Tube with Multi-Element Target

(71) Applicant: Moxtek, Inc., Orem, UT (US)

(72) Inventors: Eric Miller, Provo, UT (US); Mike Ossofsky, Springville, UT (US)

(21) Appl. No.: 17/408,930

(22) Filed: Aug. 23, 2021

Related U.S. Application Data
(60) Provisional application No. 63/080,336, filed on Sep. 18, 2020.

(51) Int. Cl. H01J 35/08; H01J 35/06; H01J 35/18

(52) U.S. Cl. CPC H01J 35/116; H01J 35/064; H01J 2235/183; H01J 2235/081; H01J 35/18

(57) ABSTRACT

An x-ray source can have increased x-ray flux and can simultaneously provide characteristic peaks and from multiple, different chemical elements. The target can include multiple layers of different chemical compositions. These layers can be distinguished by a higher atomic number, a higher energy K-alpha x-ray characteristic line, and a higher density in one layer compared to another layer. The layer that is lower in these characteristics can face the x-ray window. The layers can be formed by sputter deposition.

### CLAIM OF PRIORITY

This application claims priority to U.S. Provisional Patent Application No. 63/080,336, filed on Sep. 18, 2020, which is incorporated herein by reference.

### FIELD OF THE INVENTION

The present application is related generally to x-ray sources.

### BACKGROUND

X-rays can be used in imaging, backscatter imaging, x-ray fluorescence analysis, and electrostatic dissipation. A large voltage between a cathode and an anode of the x-ray tube, and sometimes a heated filament, can cause electrons to emit from the cathode to the anode. The anode can include a target material. The target material can generate x-rays in response to impinging electrons from the cathode.

### BRIEF DESCRIPTION OF THE DRAWINGS (DRAWINGS MIGHT NOT BE DRAWN TO SCALE)

FIG. 1a is a schematic, cross-sectional side-view of a target 14 with multiple layers of different chemical compositions, including a high-layer HL and a low-layer LL.

FIG. 1b is a schematic, cross-sectional side-view of a target 14 with multiple layers of different chemical compositions, including a high-layer HL, an intermediate-layer IL, and a low-layer LL.

FIG. 1c is a schematic, cross-sectional side-view of a target 14 with multiple layers of different chemical compositions, including a high-layer HL, a first-intermediate-layer IL₁, a second-intermediate-layer IL₂, a third-intermediate-layer IL₃, and a low-layer LL.

FIG. 2a is a schematic, cross-sectional side-view of a target 14 with multiple layers of different chemical compositions, including a high-layer HL, a first-transition-layer TL₁, and a low-layer LL.

FIG. 2b is a schematic, cross-sectional side-view of a target 14 with multiple layers of different chemical compositions, including a high-layer HL, a first-transition-layer TL₁, an intermediate-layer IL, a second-transition-layer TL₂, and a low-layer LL.

FIG. 2c is a schematic, cross-sectional side-view of a target 14 with multiple layers of different chemical compositions, including a high-layer HL, a first-transition-layer TL₁, a first-intermediate-layer IL₁, a second-transition-layer TL₂, a second-intermediate-layer IL₂, a third-transition-layer TL₃, a third-intermediate-layer IL₃, a fourth-transition-layer TL₄, and a low-layer LL.

FIG. 3 is a graph of a chemical composition in the target 14, and illustrates a smooth-transition ST of chemical composition in the first-transition-layer TL₁ and in the second-transition-layer TL₂.

FIG. 4 is a graph of a chemical composition in the target 14, and illustrates a linear-transition LT of chemical composition in the first-transition-layer TL₁ and in the second-transition-layer TL₂.

FIG. 5 is a schematic, cross-sectional side-view of a transmission-target x-ray tube 50 including a target 14 with multiple layers of different chemical compositions, and a high-side 14_{H} of the target 14 facing the electron-beam 56.

FIG. 6 is a schematic, cross-sectional side-view of a side-window x-ray tube 60 including a target 14 with multiple layers of different chemical compositions, and a low-side 14_{L} of the target 14 facing the electron-beam 56.

FIG. 7a is a schematic, cross-sectional side-view illustrating step 70a in a method of making a target 14, including sputter deposition of a high-element to form the high-layer HL.

FIG. 7b is a schematic, cross-sectional side-view illustrating step 70b in a method of making a target 14, which can follow step 70a, including sputter deposition of the high-element and an intermediate-element to form a first-transition-layer TL₁.

FIG. 7c is a schematic, cross-sectional side-view illustrating step 70c in a method of making a target 14, which can follow step 70a or step 70b, including sputter deposition of the intermediate-element to form an intermediate-layer IL.

FIG. 7d is a schematic, cross-sectional side-view illustrating step 70d in a method of making a target 14, which can follow step 70c, including sputter deposition of the intermediate-element and a low-element to form a second-transition-layer TL₂.

FIG. 7e is a schematic, cross-sectional side-view illustrating step 70e in a method of making a target 14, which can follow any of steps 70a, 70c, or step 70d, including sputter deposition of the low-element to form the low-layer LL.

FIG. 7f is a schematic, cross-sectional side-view illustrating step 70f in a method of making a target 14, which can follow step 70a, including sputter deposition of the high-element and the low-element to form a first-transition-layer TL₁.

FIG. 7g is a schematic, cross-sectional side-view illustrating step 70g in a method of making a target 14, which can follow step 70a or step 70f, including sputter deposition of the low-element to form the low-layer LL.

FIG. 8 is a schematic, cross-sectional side-view of a target 14 with multiple layers LL, TL₂, IL, TL₁, and HL of different chemical composition with respect to each other, and multiple columns, each column extending through the multiple layers LL, TL₂, IL, TL₁, and HL.

FIG. 9 is a schematic, cross-sectional side-view of a target 14 with multiple columns and a mixture of multiple different chemical elements.

FIG. 10 is a schematic, cross-sectional side-view of a transmission-target x-ray tube 100 including a target 14 with a mixture of multiple different chemical elements mechanically bonded to each other, in an amorphous mixture, or both.

FIG. 11 is a schematic, cross-sectional side-view of a side-window x-ray tube 110 including a target 14 with a mixture of multiple different chemical elements mechanically bonded to each other, in an amorphous mixture, or both.

FIG. 12a is a schematic, cross-sectional side-view illustrating step 120a in a method of making a target 14, including simultaneous sputter deposition of two different chemical elements.

FIG. 12b is a schematic, cross-sectional side-view illustrating step 120b in a method of making a target 14, including simultaneous sputter deposition of three different chemical elements.

Definitions. The following definitions, including plurals of the same, apply throughout this patent application.

As used herein, the term “adjoin” means direct and immediate contact. As used herein, the term “adjacent” includes adjoin, but also includes near or next to with other solid material(s) between the adjacent items.

As used herein, the term “amorphous mixture” means a mixture that is completely amorphous or almost completely amorphous, such as for example a mixture resulting from simultaneous sputter deposition of multiple elements.

As used herein, the term “dispersed uniformly” means dispersed exactly uniformly, dispersed uniformly within normal manufacturing tolerances, or dispersed almost exactly uniformly, such that any deviation from dispersed exactly uniformly would have negligible effect for ordinary use of the device.

As used herein, the term “homogeneous” means exactly homogeneous, homogeneous within normal manufacturing tolerances, or almost exactly homogeneous, such that any deviation from exactly homogeneous would have negligible effect for ordinary use of the device.

As used herein, the term “Kα” means the K-alpha x-ray characteristic line resulting from an electron transition to the innermost “K” shell from a 2p orbital of the second or “L” shell. “Kα” includes both “Kα₁” and “Kα₂”. “Kα₁” is higher in energy than “Kα₂”.

As used herein, a mixture of two different chemical elements “mechanically bonded” to each other means that the mixture is primarily held together by mechanical bonding rather than primarily by metallic bonding. For example, simultaneous sputter deposition of multiple elements can form a layer of material with the different elements mechanically bonded to each other.

As used herein, the term “no sputter deposition” of a particular chemical element includes negligible sputter deposition of that chemical element.

As used herein, the term “parallel” means exactly parallel, or substantially parallel, such that planes or vectors associated with the devices in parallel would intersect with an angle of ≤30°. Intersection of such planes or vectors can be ≤5°, ≤10°, or ≤20° if explicitly so stated.

As used herein, the term “x-ray tube” is not limited to tubular/cylindrical shaped devices. The term “tube” is used because this is the standard term used for x-ray emitting devices.

Unless explicitly noted otherwise herein, all temperature-dependent values are such values at 25° C.

### DETAILED DESCRIPTION

X-rays are used in backscatter imaging, in which hidden items can be identified by x-rays. For example, a gun or drugs behind a wall, or in a tire of an automobile, can be identified by emitting x-rays towards the wall, then imaging backscattered x-rays. High x-ray flux is useful for rapid analysis. A portable x-ray source is useful for taking the x-ray source to the sample. It would be beneficial to increase x-ray flux, with minimal or no increase in the size of the x-ray source, to maintain portability.

An x-ray tube can provide x-rays for backscatter imaging by impinging a target material with electrons. Each target material provides a unique range of x-ray energy with characteristic peaks of certain energies. It is desirable to provide characteristic peak energies that match materials in the item analyzed. If the x-ray energy is too high, then the x-rays will pass through and not provide the desired backscatter image. If the x-ray energy is too low, then the x-rays won't penetrate deeply enough or won't provide the desired backscatter image. Therefore, it would be helpful to provide an x-ray target that emits high and low energy x-rays.

X-rays are used in x-ray fluorescence analysis. A target material in the x-ray tube is selected with a peak near x-ray fluorescence energy of the sample to be analyzed. Sometimes there is a desire to analyze different materials, with a large range of x-ray fluorescence energies. Therefore, it would be helpful for the x-ray source to provide a large range of x-ray energies, from multiple, different chemical elements.

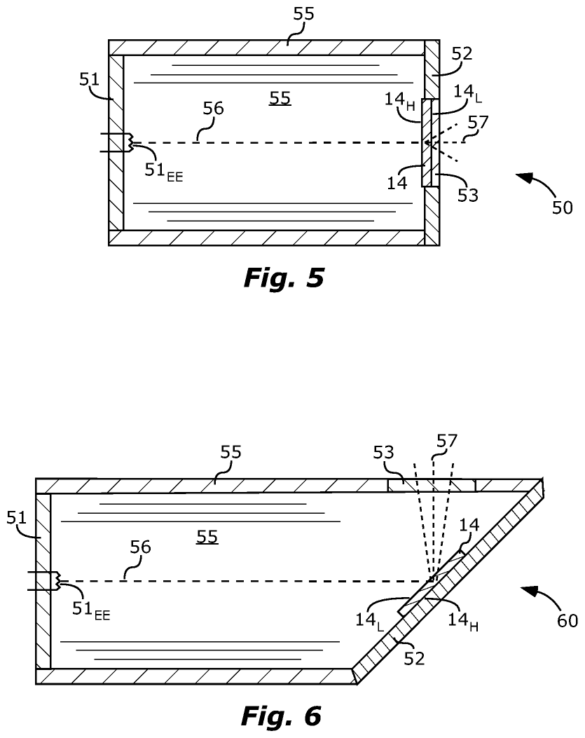

The x-ray tubes herein include a target 14 with materials that will emit x-rays 57 (see FIGS. 5-6 and 10-11) in response to impinging electrons. The target can be made of multiple materials, to provide a large range of x-ray energies, from multiple, different chemical elements. Use of multiple materials can result in higher x-ray flux.

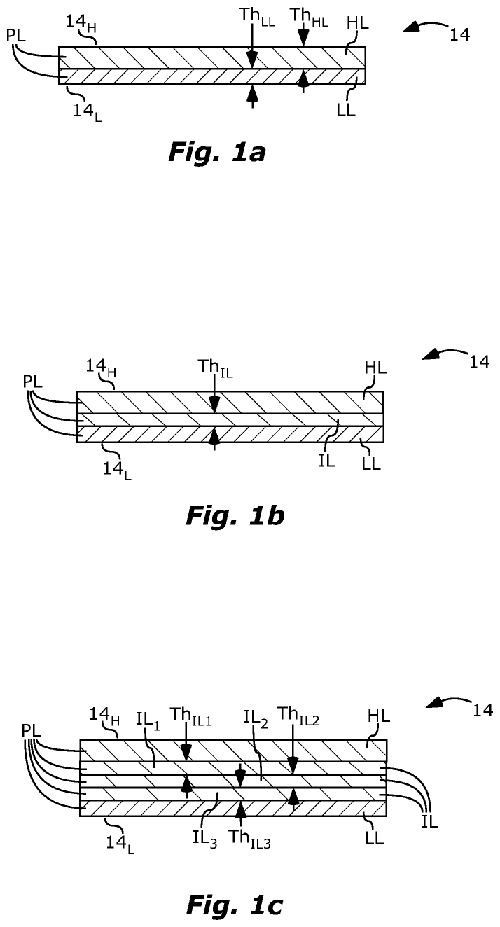

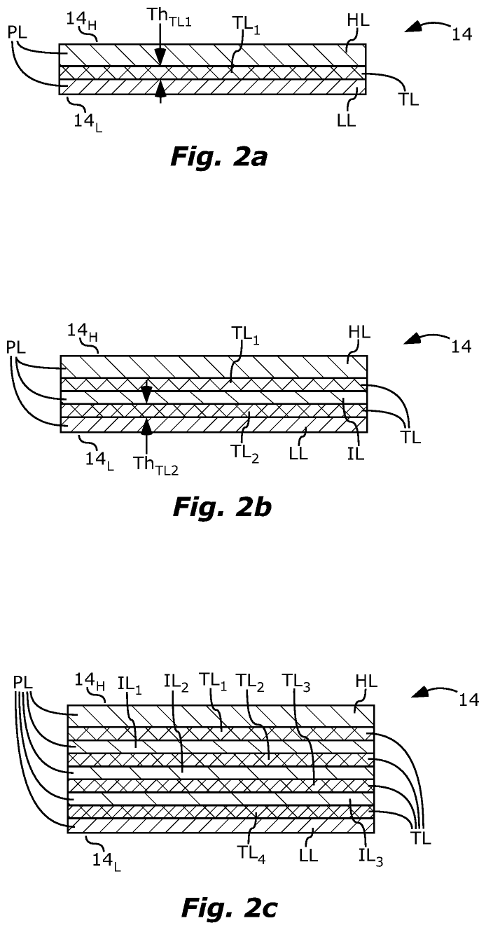

As illustrated in FIGS. 1a through 8, the target 14 can include multiple primary-layers PL with different material composition with respect to each other. There can be an abrupt change of chemical composition between primary-layers PL, as illustrated in FIGS. 1a-1c. As illustrated in FIGS. 2a-2c, there can be a transition-layer TL between adjacent primary-layers PL. As illustrated in FIGS. 9-12b, the target 14 can be a mixture of multiple, different chemical elements mechanically bonded to each other, in an amorphous mixture, or both.

In all of these embodiments (FIGS. 1a-12b), the target 14, with multiple, different chemical elements, can provide high x-ray flux with peaks from multiple, different chemical elements. Combining multiple elements can result in an increased total x-ray flux by combining characteristic peaks from each of the multiple elements. Combining multiple elements can provide a broader range of characteristic peaks, thus allowing analysis of a broader spectrum of chemical elements. The different elements can have a large spread of energy between characteristic peaks, thus allowing a single analysis of very diverse chemical elements.

Multi-element targets 14, with multiple primary-layers PL, are illustrated in FIGS. 1a-2c. Each primary-layer PL can have a different material composition with respect to other primary-layers. A material composition of each primary-layer PL can be homogeneous throughout the primary-layer PL.

The primary-layers PL can include a high-layer HL and a low-layer LL, as illustrated in FIGS. 1a and 2a. The high-layer HL and the low-layer LL can have different chemical compositions with respect to each other, which can provide an increased total x-ray flux and a broader range of characteristic peaks. To further increase total x-ray flux and broaden the range of characteristic peaks, the primary-layers PL can further comprise intermediate-layer(s) TL, as illustrated in FIGS. 1b, 1c, 2b, and 2c.

For simplicity of design and manufacture of the target 14, and efficiency of use of the x-ray tube, the high-layer HL can have a high percent of one element, called a high-element, the low-layer LL can have a high percent of one element, called a low-element, and the intermediate-layer IL can have a high percent of one element, called an intermediate-element.

For example, the weight percent of the high-element in the high-layer HL can be higher than any other element in the high-layer HL. The weight percent of the high-element in the high-layer HL can be ≥50%, ≥75%, ≥90%, or ≥98%. The weight percent of the low-element in the low-layer LL can be higher than any other element in the low-layer LL. The weight percent of the low-element in the low-layer LL can be ≥50%, ≥75%, ≥90%, or ≥98%. The weight percent of the intermediate-element in the intermediate-layer IL can be higher than any other element in the intermediate-layer IL. The weight percent of the intermediate-element in the intermediate-layer TL can be ≥50%, ≥75%, ≥90%, or ≥98%.

The high-element, the low-element, and the intermediate-element can all be different with respect to each other. If multiple chemical elements in a single layer have the same, highest weight percent, then the element, among these multiple chemical elements, with the highest atomic number is the high-element, the low-element, or the intermediate-element.

The primary-layers PL can be arranged according to material-characteristic(s), such as atomic number, density, x-ray fluorescent energy, absorption edge, or combinations thereof. The high-layer HL can have a highest value among the primary-layers PL of the selected material-characteristic(s). The low-layer LL can have a lowest value among the primary-layers PL of the selected material-characteristic(s). The intermediate-layer IL can have an intermediate value, between that of the high-layer HL and the low-layer LL, of the selected material-characteristic(s). If there is more than one intermediate-layer IL, then the multiple intermediate-layers IL can be ordered similarly, with increasing values of the selected material-characteristic(s) moving closer to the high-layer HL, and decreasing values of the selected material-characteristic(s) moving closer to the low-layer LL.

Following are example relative material-characteristics of the primary-layers PL: Z(H)>Z(L), Z(H)>Z(I), Z(I)>Z(L), Kα₁(H)>Kα₁(L), Kα₁(H)>Kα₁(I), Kα₁(I)>Kα₁(L), ρ_{H}>ρ_{L}, ρ_{H}>ρ_{I}, ρ_{I}>ρ_{L}. Z(H) is an atomic number of the high-element. Z(L) is an atomic number of the low-element. Z(I) is an atomic number of the intermediate-element. Kα₁(H) is a higher energy K-alpha x-ray characteristic line of the high-element. Kα₁(L) is a higher energy K-alpha x-ray characteristic line of the low-element. Kα₁(I) is a higher energy K-alpha x-ray characteristic line of the intermediate-element. ρ_{H} is a density of the high-element. ρ_{L} is a density of the low-element. ρ_{I} is a density of the intermediate-element.

There can be a large enough difference between the atomic numbers and/or Kα₁ of the primary-layers PL to provide a sufficiently broad range of characteristic peaks. For example, Z(H)−Z(L)≥5, Z(H)−Z(L)≥10, Z(H)−Z(L)≥20, Z(H)−Z(L)≥30, or Z(H)−Z(L)≥40; Z(H)−Z(L)≤50, Z(H)−Z(L)≤60, or Z(H)−Z(L)≤75; Kα₁(H)−Kα₁(L)≥5 keV, Kα₁(H)−Kα₁(L)≥15 keV, Kα₁(H)−Kα₁(L)≥25 keV, Kα₁(H)−Kα₁(L)≥50 keV, or Kα₁(H)−Kα₁(L)≥70 keV.

Listed in Table 1 are example elements, with properties, for the primary-layers PL. This table assumes five primary-layers PL, including three intermediate-layers IL₁, IL₂, and IL₃, as illustrated in FIGS. 1c and 2c. The layers ordered as follows: the high-layer HL, a first-intermediate-layer IL₁, a second intermediate-layer IL₂, a third intermediate-layer IL₃, then the low-layer LL. The far right column suggests which elements are likely suitable for each layer.

TABLE 1

| | | | | density | |
|---|---|---|---|---|---|
| Symbol | Element | Z | Kalpha1 | (g/cm³) | H,I,L |
| U | uranium | 92 | 98.4 | 19.1 | HL |
| Th | thorium | 90 | 93.3 | 11.7 | HL |
| Au | gold | 79 | 68.8 | 19.3 | IL1 |
| Pt | platinum | 78 | 66.8 | 21.45 | IL1 |
| Re | rhenium | 75 | 61.1 | 21.02 | IL1 |
| W | tungsten | 74 | 59.3 | 19.3 | IL1 |
| Ta | tantalum | 73 | 57.5 | 16.65 | IL1 |
| Hf | hafnium | 72 | 55.8 | 13.07 | IL1 |
| Gd | gadolinium | 64 | 43.0 | 7.9 | IL2 |
| Ag | silver | 47 | 22.2 | 10.49 | IL3 |
| Rh | rhodium | 45 | 20.2 | 12.4 | IL3 |
| Mo | molybdenum | 42 | 17.5 | 10.28 | IL3 |
| Cu | copper | 29 | 8.0 | 8.96 | LL |

For example, the target 14 can include the following primary-layers PL in the following order: the high-layer HL can be thorium with thickness Th_{HL}=3.6 μm, the first-intermediate-layer IL₁ can be rhenium with thickness Th_{IL}=2.3 μm, the second-intermediate-layer IL₂ can be gadolinium with thickness Th_{IL2}=2.8 μm, the third-intermediate-layer IL₃ can be molybdenum with thickness Th_{IL3}=1.9 μm, and the low-layer LL can be copper with thickness Th_{LL}=4.1 μm (see FIG. 1c).

As illustrated in FIGS. 2a-2c, the target 14 can include a transition layer TL between each pair of primary-layers PL. Each transition layer TL can have an intermediate chemical composition between chemical compositions of the adjacent primary-layers PL.

Adjoining primary-layers PL can develop thermal stress as the target 14 expands and contracts during temperature changes. Placement of the transition layer TL between the primary-layers PL can reduce this thermal stress.

An abrupt change from a chemical composition in one primary-layer PL to a different chemical composition in an adjoining primary-layer PL can result in a weak chemical bond between the primary-layers PL. Placement of the transition layer TL between the primary-layers PL can improve the chemical bond between the primary-layers PL.

Electrons and heat can build up at a junction between primary-layers PL, which can result in failure or reduced performance of the target 14. Placement of the transition layer TL between the primary-layers PL can improve electrical current and heat flow through the target 14.

As illustrated in FIG. 2a, a first-transition-layer TL₁ can be sandwiched between the high-layer HL and the low-layer LL. The first-transition-layer TL₁ can have an intermediate chemical composition between chemical compositions of the high-layer HL and the low-layer LL.

As illustrated in FIG. 2b, the target can further comprise an intermediate-layer IL and a second-transition-layer TL₂. The second-transition-layer TL₂ can be sandwiched between the intermediate-layer IL and the low-layer LL. Each transition-layer TL can have an intermediate chemical composition between chemical compositions of adjacent primary-layers PL. The first-transition-layer TL₁ can have an intermediate chemical composition between chemical compositions of the intermediate-layer IL and the high-layer HL. The second-transition-layer TL₁ can have an intermediate chemical composition between chemical compositions of the intermediate-layer IL and the low-layer LL.

The target 14 of FIG. 2c includes five primary-layers PL and four transition-layers TL. Each transition-layer TL can have an intermediate chemical composition between chemical compositions of adjacent primary-layers PL.

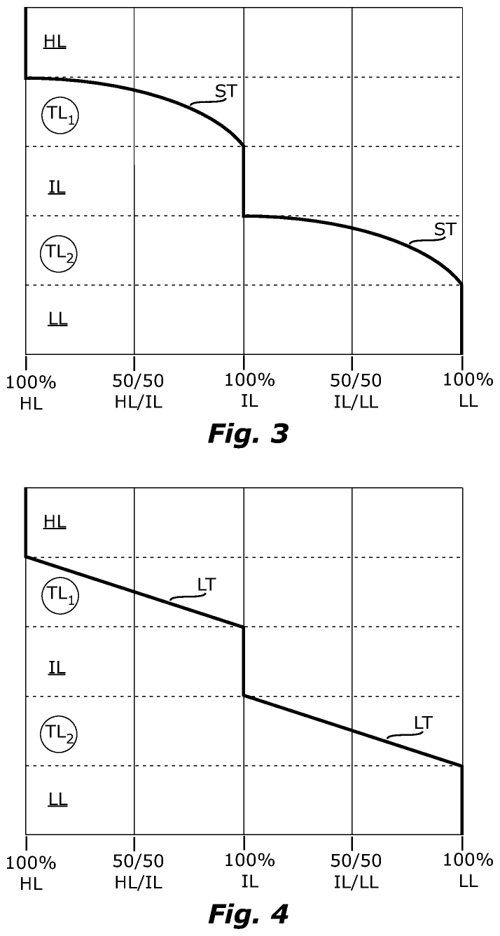

As illustrated in FIG. 3, there can be a smooth-transition ST of chemical composition in the transition layer(s) TL between chemical compositions of the primary-layers PL. This smooth-transition ST, instead of abrupt changes of chemical composition, can help reduce thermal stress, strengthen chemical bonding in the target 14, and increase electrical current and heat flow through the target 14.

As illustrated in FIG. 4, there can be a linear-transition LT of chemical composition in the transition layer(s) TL between chemical compositions of the primary-layers PL. The linear-transition LT can help reduce thermal stress, strengthen chemical bonding in the target 14, and increase electrical current and heat flow through the target 14.

In FIGS. 3 & 4, the y-axis represents distance through or location in the target 14, and the x-axis represents chemical composition. A linear-transition LT is a smooth-transition ST. A smooth-transition ST might or might not be a linear-transition LT.

An example target 14 includes gold as the high-layer HL with thickness Th_{HL}=5 μm, gadolinium as the intermediate-layer IL with thickness Th_{IL}=4 μm, and silver as the low-layer LL with thickness Th_{LL}=3 μm. A first-transition-layer TL₁, with a thickness Th_{TL1}=3 μm, is sandwiched between the high-layer HL and the intermediate-layer IL, with a smooth-transition ST of chemical composition from pure gold to pure gadolinium. A second-transition-layer TL₂, with a thickness Th_{TL2}=3 μm, is sandwiched between the intermediate-layer IL and the low-layer LL, with a smooth-transition ST of chemical composition from pure gadolinium to pure silver.

As illustrated in FIGS. 5-6, x-ray tubes 50 and 60 can comprise a cathode 51 and an anode 52 electrically insulated from one another (e.g. by a ceramic, glass, or other electrically-insulative enclosure 55). The cathode 51 can be configured to emit electrons in an electron-beam 56 towards the anode 52. The cathode 51 can include an electron-emitter 51_{EE}, such as for example a filament, to emit the electron-beam 56. The x-ray tube 50 or 60 can include a single electron-emitter 51_{EE} (i.e. only one electron-emitter 51_{EE}). The anode 52 can include a target 14 configured to emit x-rays 57 out of the x-ray tube 50 or 60 in response to impinging electrons from the cathode 51. An x-ray window 53 can be located to allow transmission of the x-rays 57 out of the x-ray tube 50 or 60.

The high-layer HL can be located at a high-side 14_{H} of the target 14 and the low-layer LL can be located at a low-side 14_{H} of the target 14. The high-side and the low-side 14_{H} of the target 14 can be located for increased x-ray flux.

As illustrated in FIG. 5, the x-ray tube 50 can be a transmission-target x-ray tube. The x-ray window 53 can adjoin the target 14. The high-layer HL of the target 14 can face the electron-beam 56. The low-layer LL can face and/or adjoin the x-ray window 53.

As illustrated in FIG. 6, the x-ray tube 60 can be a side-window x-ray tube. The high-layer HL of the target 14 can face away from the electron-beam. The low-layer LL can face the electron-beam 56 and the x-ray window 53. The low-layer LL can be spaced apart from the x-ray window 53. The target 14 can be spaced apart from the x-ray window 53.

For x-ray tube 50 or 60, with the target 14 arranged as described above, high energy x-rays 57 generated in the high-layer HL can pass through the low-layer LL and any intermediate-layer(s) IL and out of the x-ray tube 50. Intermediate energy x-rays 57 generated in any intermediate-layer(s) IL can pass through the low-layer LL and out of the x-ray tube 50. Low energy x-rays 57 generated in the low-layer LL can pass out of the x-ray tube 50 without being attenuated by the high-layer HL or by the intermediate-layer(s) IL.

As illustrated in FIGS. 5-6, x-ray tubes 50 and 60 include a single electron emitter 51_{EE}, but can still emit simultaneously and continuously an x-ray spectrum from multiple elements. X-ray tubes 50 and 60, with a single electron emitter 51_{EE} can emit simultaneously and continuously an x-ray spectrum from at least two of the high-element in the high-layer HL, the intermediate-element in the intermediate-layer IL, and the low-element in the low-layer LL.

The target 14 can be formed by sputter deposition to form a target of multiple layers of different materials and to facilitate formation of combinations of chemical elements. For example, some chemical combinations can be formed by sputter deposition that might not be possible to form by melting to create an alloy.

Sputter deposition can also result in a strong bond between adjacent layers, thus avoiding separation of layers that can result from welding foils of different materials together.

Sputter deposition can form a transition-layer TL between adjacent primary-layers PL, thus avoiding electron buildup at a boundary between the layers, and minimizing thermal stresses due to different coefficients of thermal expansion between the different primary-layers PL.

A method of making the target 14 can comprise some or all of the following steps, which can be performed in the following order or opposite order. Components of the target 14, and the target 14 itself, can have properties as described above. Any additional description of properties of the target 14 in the method below, not described above, are applicable to the above-described target 14.

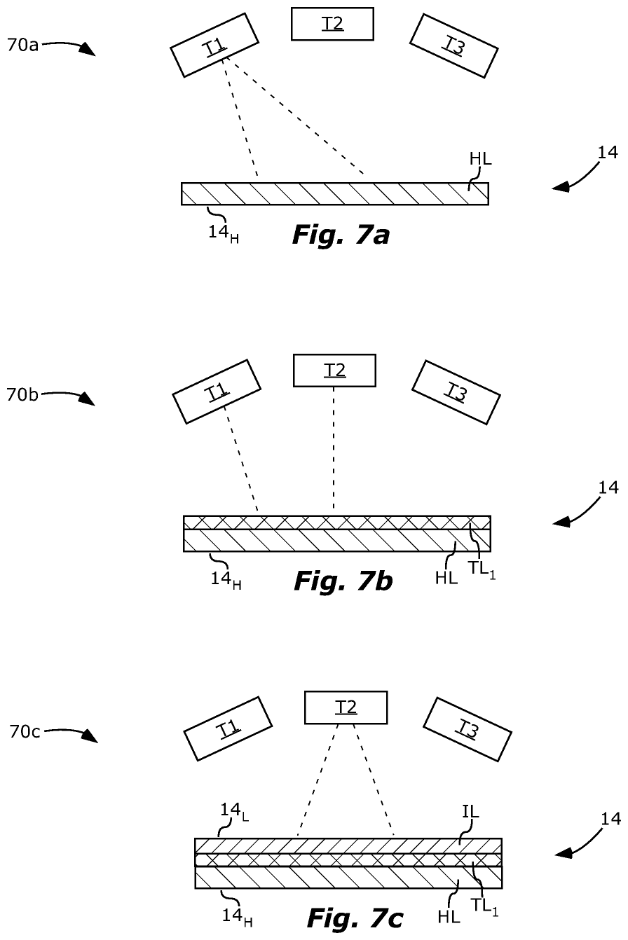

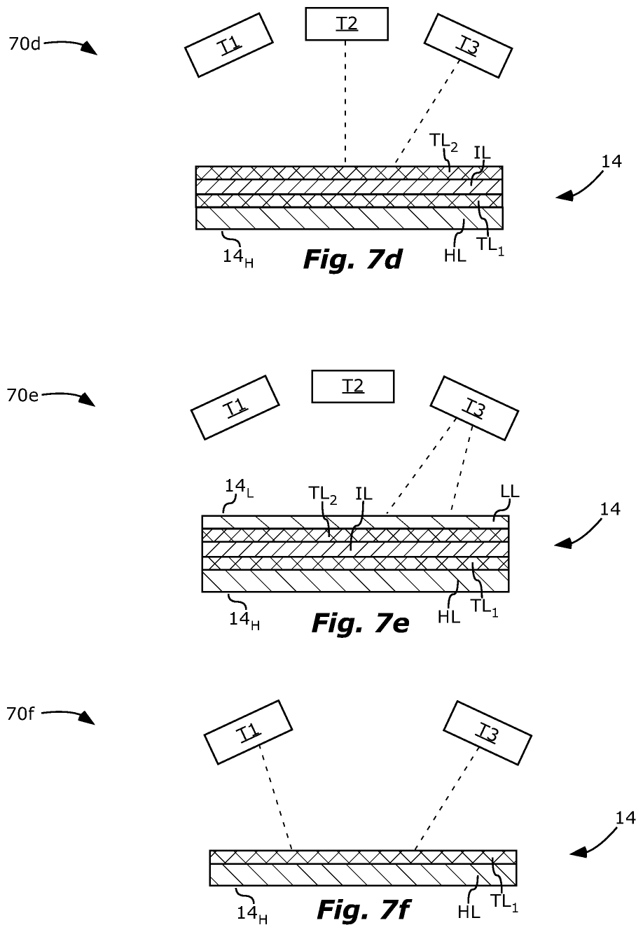

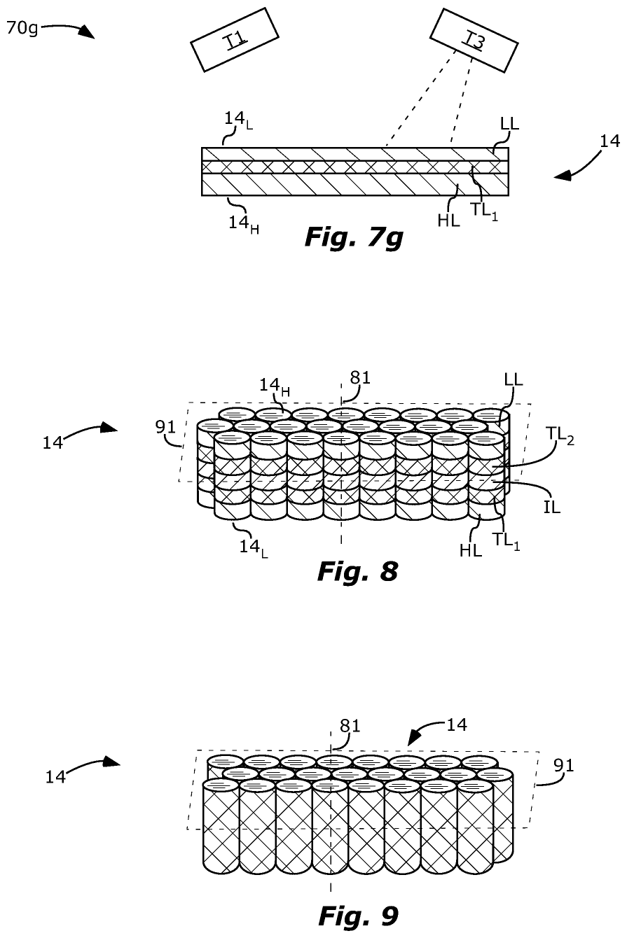

As illustrated in FIG. 7a, step 70a of the method can include sputter deposition of a material composition of the high-layer HL, which can include sputter deposition of the high-element. Step 70a can include providing power to a single target T1. This step 70a can include sputter deposition of the high-element with no sputter deposition of the low-element or any intermediate-element.

As illustrated in FIG. 7b, step 70b of the method can include sputter deposition of a material composition of the first-transition-layer TL₁, which can include simultaneous sputter deposition of the high-element and the intermediate-element. Step 70b can include simultaneously providing power to two targets T1 and T2. Step 70b can include gradually reducing power to target T1 and gradually increasing power to target T2.

As illustrated in FIG. 7c, step 70c of the method can include sputter deposition of a material composition of the intermediate-layer IL, which can include sputter deposition of the intermediate-element. Step 70c can include providing power to a single target T2. This step 70c can include sputter deposition of the intermediate-element with no sputter deposition of the low-element or of the high-element.

As illustrated in FIG. 7d, step 70d of the method can include sputter deposition of a material composition of the second-transition-layer TL₂, which can include simultaneous sputter deposition of the intermediate-element and the low-element. Step 70d can include simultaneously providing power to two targets T2 and T3. Step 70d can include gradually reducing power to target T2 and gradually increasing power to target T3.

As illustrated in FIG. 7e, step 70e of the method can include sputter deposition of a material composition of the low-layer LL, which can include sputter deposition of the low-element. Step 70e can include providing power to a single target T3. This step 70e can include sputter deposition of the low-element with no sputter deposition of the high-element or any intermediate-element.

As illustrated in FIG. 7f, step 70f of the method can include sputter deposition of a material composition of the first-transition-layer TL₁, which can include simultaneous sputter deposition of the high-element and the low-element. Step 70f can include simultaneously providing power to two targets T1 and T3. Step 70f can include gradually reducing power to target T1 and gradually increasing power to target T3.

As illustrated in FIG. 7g, step 70g of the method can include sputter deposition of a material composition of the low-layer LL, which can include sputter deposition of the low-element. Step 70g can include providing power to a single target T3. This step 70e can include sputter deposition of the low-element with no sputter deposition of the high-element.

The target 14 in FIG. 1a can be made by steps 70a and 70g in this order or reverse order. The target 14 in FIG. 1b can be made by steps 70a, 70c, and 70e, in this order or in reverse order (70e, 70c, then 70a). The target 14 in FIG. 1c can be made similar to the target of FIG. 1b, except that step 70c is repeated twice with different intermediate material targets.

The target 14 in FIG. 2a can be made by steps 70a, 70f, and 70g, in this order or in reverse order (70g, 70f, then 70a). The target 14 in FIG. 2b can be made by steps 70a, 70b, 70c, 70d, and 70e, in this order or in reverse order (70e, 70d, 70c, 70b, then 70a). The target 14 in FIG. 2c can be made similar to the target of FIG. 2b, except that steps similar to 70c and 70d are repeated twice with different intermediate material targets.

As illustrated in FIGS. 8-9, the target 14 can include multiple columns. The columns can create anisotropic properties throughout the target 14. Sputter deposition can form the columns. Normally, the columns in an actual target, formed by sputter deposition, are not as orderly as illustrated in FIGS. 8-9.

As illustrated in FIG. 8, each column can extend through the high-layer HL, any transition layer TL, any intermediate-layer IL, and the low-layer LL. The columns of FIG. 8 can be formed as described above and shown in FIGS. 7a-7g.

As illustrated in FIG. 9, each column can include a mixture of two different chemical elements. The columns of FIG. 9 can be formed as described below and shown in FIGS. 12a-12b.

In both FIGS. 8 and 9, a longitudinal-axis 81 of each column can extend parallel to the electron-beam 56. A material composition of the target 14 can be uniform in any plane 91 perpendicular to the longitudinal-axis 81.

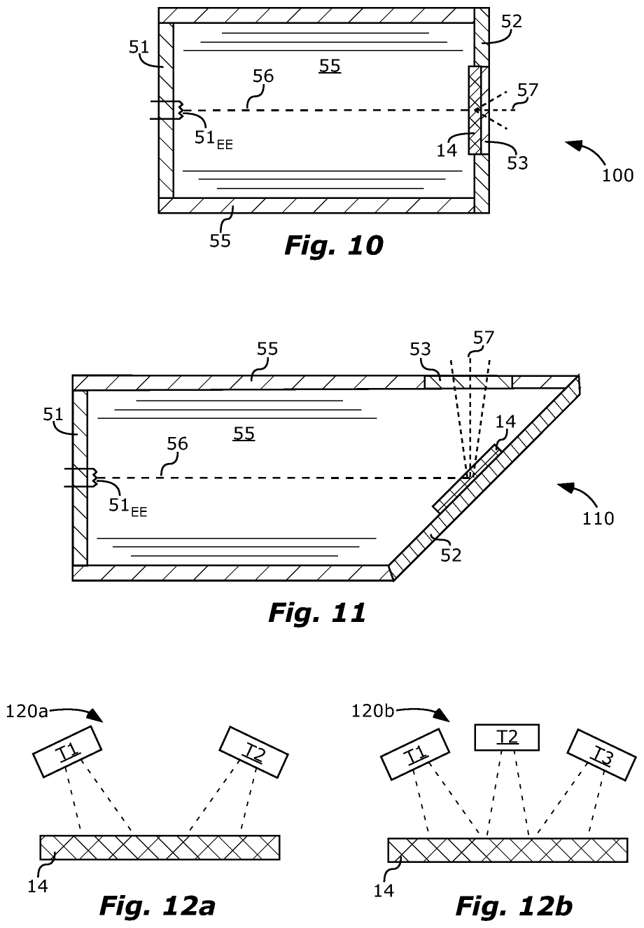

As illustrated in FIGS. 10-11, x-ray tubes 100 and 110 can comprise a cathode 51 and an anode 52 electrically insulated from one another (e.g. by a ceramic, glass, or other electrically-insulative enclosure 55). The cathode 51 can be configured to emit electrons in an electron-beam 56 towards the anode 52. The cathode 51 can emit the electron-beam 56 by an electron-emitter 51_{EE}, such as for example a filament. The electron-emitter 51_{EE} can be a single electron emitter 51_{EE}. The anode 52 can include a target 14 configured to emit x-rays 57 out of the x-ray tube 100 or 110 in response to impinging electrons from the cathode 51. An x-ray window 53 can be located to allow transmission of the x-rays 57 out of the x-ray tube 100 or 110.

The target 14 can include an amorphous mixture of two, three, or more different chemical elements. The target 14 can include a mixture of two, three, or more different chemical elements mechanically bonded to each other. The mixture (amorphous, mechanically bonded, or both) can be dispersed evenly throughout the target 14. There can be a substantial weight percent of each of the different chemical elements, such as for example ≥1%, ≥5%, ≥10%, or ≥25%, and a total weight percent of all chemical elements in the target material is 100%.

The target 14 can be made as described below in reference to FIGS. 12a-12b. The mixture can allow emission of x-rays from multiple, different chemical elements, thus providing additional characteristic peaks and broadening the range of the characteristic peaks.

The amorphous mixture, the mechanical-bond, or both can extend throughout the entire target 14. The amorphous mixture, the mechanical-bond, or both can be uniform in material composition throughout the entire target 14. The multiple, different chemical elements can be dispersed uniformly throughout the target 14.

There can be a large enough difference between the atomic numbers, the Kα₁, or both, of the two different chemical elements to provide a sufficiently broad range of characteristic peaks. For example, Z(1)−Z(2)≥5, Z(1)−Z(2)≥10, Z(1)−Z(2)≥20, Z(1)−Z(2)≥30, or Z(1)−Z(2)≥40; Z(1)−Z(2)≤50, Z(1)−Z(2)≤60, or Z(1)−Z(2)≤75; Kα₁(1)−Kα₁(2)≥5 keV, Kα₁(1)−Kα₁(2)≥15 keV, Kα₁(1)−Kα₁(2)≥25 keV, Kα₁(1)−Kα₁(2)≥50 keV, or Kα₁(1)−Kα₁(2)≥70 keV. Z(1) is an atomic number of an element of a highest atomic number in the mixture that has a weight percent of at least 10%. Z(2) is an atomic number of an element of lowest atomic number in the mixture that has a weight percent of at least 10%. Kα₁(1) is a Kα₁ value of an element of highest Kα₁ value in the mixture that has a weight percent of at least 10%. Kα₁(2) is a Kα₁ value of an element of lowest Kα₁ value in the mixture that has a weight percent of at least 10%. Table 1 above lists example elements for the mixture.

As illustrated in FIGS. 10-11, a method of using the x-ray tube 100 or 110 includes emitting the electron-beam 56 from a single electron emitter 51_{EE} in the cathode 51 and emitting simultaneously and continuously an x-ray spectrum 57 from each of the multiple, different chemical elements in the target 14.

Illustrated in FIGS. 12a and 12b are methods of making a target 14 with an amorphous mixture of multiple different chemical elements, with a mixture of multiple different chemical elements mechanically bonded, or both. The method includes simultaneous sputter deposition of the two different chemical elements (FIG. 12a) or simultaneous sputter deposition of the three different chemical elements (FIG. 12b). The mechanical bond, the amorphous mixture, or both can result from sputter deposition to form the target 14. The mechanical bond and the amorphous mixture can improve x-ray spot size.

What is claimed is:

1. An x-ray tube comprising:
a cathode and an anode electrically insulated from one another, the cathode configured to emit electrons in an electron-beam towards the anode, the anode including a target configured to generate and emit x-rays out of the x-ray tube in response to impinging electrons from the cathode, and an x-ray window located to allow the x-rays generated in the target material to emit out of the x-ray tube;
the target has multiple primary-layers of different chemical compositions, including a high-layer and a low-layer, the high-layer and the low-layer have different chemical compositions with respect to each other, and the low-layer faces the x-ray window;
the high-layer includes a high-element, a weight percent of the high-element in the high-layer is higher than any other element in the high-layer;
the low-layer includes a low-element, a weight percent of the low-element in the low-layer is higher than any other element in the low-layer; and
Z(H)>Z(L), where Z(H) is an atomic number of the high-element and Z(L) is an atomic number of the low-element.

2. The x-ray tube of claim 1, wherein:
the multiple primary-layers further comprise an intermediate-layer;
the intermediate-layer includes an intermediate-element, a weight percent of the intermediate-element in the intermediate-layer is higher than any other element in the intermediate-layer;
the intermediate-layer is sandwiched between the high-layer and the low-layer;
the high-layer, the intermediate-layer, and the low-layer have different chemical compositions with respect to each other; and
Z(I)>Z(L), where Z(I) is an atomic number of the intermediate-element.

3. The x-ray tube of claim 1, wherein ρ_{H}>ρ_{L}, where ρ_{H} is a density of the high-element and ρ_{L} is a density of the low-element.

4. The x-ray tube of claim 3, wherein:
the multiple primary-layers further comprise an intermediate-layer;
the intermediate-layer includes an intermediate-element, a weight percent of the intermediate-element in the intermediate-layer is higher than any other element in the intermediate-layer;
the intermediate-layer is sandwiched between the high-layer and the low-layer;
the high-layer, the intermediate-layer, and the low-layer have different chemical compositions with respect to each other; and
ρ_{I}>ρ_{L}, where ρ_{I} is a density of the intermediate-element.

5. The x-ray tube of claim 1, wherein the x-ray tube is a transmission-target x-ray tube and the high-layer faces the electron-beam.

6. The x-ray tube of claim 1, wherein the x-ray tube is a side-window x-ray tube and the low-layer faces the electron-beam.

7. The x-ray tube of claim 1, wherein the target includes multiple columns; each column extends through the high-layer and the low-layer; and a longitudinal-axis of each column extends parallel to the electron-beam.

8. A method of making the target of claim 1, the method including sputter deposition of the high-element and sputter deposition of the low-element, at separate times with respect to each other.

9. A method of making the target of claim 1, the method including:
step 1: sputter deposition of the high-element with no sputter deposition of the low-element;
step 3: sputter deposition of the low-layer with no sputter deposition of the high-element; and
step 2: simultaneous sputter deposition of the high-element and the low-element, step 2 occurring between step 1 and step 3.

10. A method of using the x-ray tube of claim 1, the method including:
emitting the electron-beam from a single electron emitter in the cathode; and
emitting simultaneously and continuously an x-ray spectrum from the high-element and the low-element.

11. An x-ray tube comprising:
a cathode and an anode electrically insulated from one another, the cathode configured to emit electrons in an electron-beam towards the anode, the anode including a target configured to generate and emit x-rays out of the x-ray tube in response to impinging electrons from the cathode, and an x-ray window located to allow the x-rays generated in the target material to emit out of the x-ray tube;
the target has multiple primary-layers of different chemical compositions, including a high-layer and a low-layer, the high-layer and the low-layer have different chemical compositions with respect to each other, and the low-layer faces the x-ray window;
the high-layer includes a high-element, a weight percent of the high-element in the high-layer is higher than any other element in the high-layer;
the low-layer includes a low-element, a weight percent of the low-element in the low-layer is higher than any other element in the low-layer; and
Kα₁(H)>Kα₁(L), where Kα₁(H) is a higher energy K-alpha x-ray characteristic line of the high-element and Kα₁(L) is a higher energy K-alpha x-ray characteristic line of the low-element.

12. The x-ray tube of claim 11, wherein:
the multiple primary-layers further comprise an intermediate-layer;
the intermediate-layer includes an intermediate-element, a weight percent of the intermediate-element in the intermediate-layer is higher than any other element in the intermediate-layer;
the intermediate-layer is sandwiched between the high-layer and the low-layer;
the high-layer, the intermediate-layer, and the low-layer have different chemical compositions with respect to each other; and
Kα₁(I)>Kα₁(L), where Kα₁(I) is a higher energy K-alpha x-ray characteristic line of the intermediate-element.

13. The x-ray tube of claim 11, wherein the target includes multiple columns; each column extends through the high-layer and the low-layer; and a longitudinal-axis of each column extends parallel to the electron-beam.

14. An x-ray tube comprising:
a cathode and an anode electrically insulated from one another, the cathode configured to emit electrons in an electron-beam towards the anode, and the anode including a target configured to emit x-rays out of the x-ray tube in response to impinging electrons from the cathode; and
the target having multiple layers of different chemical compositions, including a high-layer, a first-transition-layer, and a low-layer, the first-transition-layer is sandwiched between the high-layer and the low-layer, the high-layer and the low-layer have different chemical compositions with respect to each other, and the first-transition-layer has an intermediate chemical composition between chemical compositions of the high-layer and the low-layer.

15. The x-ray tube of claim 14, wherein:
the high-layer includes a high-element, a weight percent of the high-element in the high-layer is higher than any other element in the high-layer;
the low-layer includes a low-element, a weight percent of the low-element in the low-layer is higher than any other element in the low-layer;
Z(H)>Z(L), where Z(H) is an atomic number of the high-element and Z(L) is an atomic number of the low-element;
Kα₁(H)>Kα₁(L), where Kα₁(H) is a higher energy K-alpha x-ray characteristic line of the high-element and Kα₁(L) is a higher energy K-alpha x-ray characteristic line of the low-element; and
ρ_{H}>ρ_{L}, where ρ_{H} is a density of the high-element and ρ_{L} is a density of the low-element.

16. The x-ray tube of claim 14, wherein the first-transition-layer includes a smooth-transition of chemical composition from a chemical composition of the high-layer to a chemical composition of the low-layer.

17. The x-ray tube of claim 14, wherein the first-transition-layer includes a linear-transition of chemical composition from a chemical composition of the high-layer to a chemical composition of the low-layer.

18. The x-ray tube of claim 14, wherein:
the multiple layers of different chemical compositions further comprise a second-transition-layer and an intermediate-layer;
an order of the multiple layers is the high-layer, the first-transition-layer, the intermediate-layer, the second-transition-layer, then the low-layer;
the high-layer, the low-layer, and the intermediate-layer have different chemical compositions with respect to each other; and
the second-transition-layer has an intermediate chemical composition between chemical compositions of the low-layer and the intermediate-layer.

19. The x-ray tube of claim 18, wherein:
the high-layer includes a high-element, a weight percent of the high-element in the high-layer is higher than any other element in the high-layer;
the low-layer includes a low-element, a weight percent of the low-element in the low-layer is higher than any other element in the low-layer;
the intermediate-layer includes an intermediate-element, a weight percent of the intermediate-element in the intermediate-layer is higher than a weight percent of any other element in the intermediate-layer; and
Z(H)>Z(I)>Z(L), where Z(H) is an atomic number of the high-element, Z(L) is an atomic number of the low-element, and Z(I) is an atomic number of the intermediate-element.

20. A method of making the target of claim 14, the method including:
sputter deposition of the high-layer,
sputter deposition of the low-layer, and
sputter deposition of the first-transition-layer between sputter deposition of the high-layer and sputter deposition of the low-layer.
